(19) United States
(12) Patent Application Publication
(10) Pub. No.: US 2024/0427948 A1
(43) Pub. Date: Dec. 26, 2024

(54) Systems and Methods for the Inverse Modeling of Parts and Tools

(71) Applicant: ARIS TECHNOLOGY LLC, Batavia, IL (US)

(72) Inventors: Mingu Kang, Chicago, IL (US); Bradley D. Johnson, Plainfield, IL (US); James Clark, Baden, PA (US); Marc Alban, San Antonio, TX (US)

(21) Appl. No.: 18/212,898

(22) Filed: Jun. 22, 2023

(51) Int. Cl. G06F 30/10; G06T 17/20

(52) U.S. Cl. CPC G06F 30/10; G06T 17/20; G06F 2119/18; G06T 2200/08

(57) ABSTRACT

A method for inverse modeling of a part includes: importing a first electronic file comprising a three-dimensional reference design of a part; manufacturing the part based on the first electronic file; collecting metrology data for the part and creating a second electronic file comprising the collected metrology data; comparing the first electronic file and the second electronic file and determining a deviation based on the comparison; determining whether the deviation is acceptable; and in the event the deviation is determined not to be acceptable, revising the three-dimensional reference design of the part or modifying a manufacturing process for the part.

### FIELD OF THE INVENTION

This disclosure relates generally to inverse modeling systems and methods and, more particularly, to inverse modeling systems and methods for generating parts and manufacturing tools.

### BACKGROUND

Currently, a part design is created by design engineers in a form of two-dimensional (2D) drawings or three-dimensional (3D) computer-aided-design (CAD) design and the manufacturing engineers and floor operators insert the part design into the manufacturing equipment or process to manufacture the part(s) from the design. However, there are numerous input parameters that go into any manufacturing process that impact the quality of the part, resulting in variation in part dimensions across the production volume even if the same part design was used to manufacture the parts.

### SUMMARY

In accordance with one example of the present invention, a method for inverse modeling of a part comprises: importing, by one or more processors, a first electronic file comprising a three-dimensional reference design of a part into a computer memory; manufacturing the part based on the first electronic file; collecting metrology data for the part, creating a second electronic file, by the one or more processors, comprising the collected metrology data for the part, and saving, into the computer memory, the second electronic file; comparing, by the one or more processors, the first electronic file and the second electronic file and determining a deviation based on the comparison of the first electronic file and the second electronic file; determining, by the one or more processors, whether the deviation is acceptable; and executing one of: (a) in the event the deviation is determined not to be acceptable, revising the three-dimensional reference design of the part or modifying a manufacturing process for the part; or (b) in the event the deviation is determined to be acceptable, continuing to manufacture the part based on the first electronic file.

In further accordance with any one or more of the foregoing examples of the present invention, a method for inverse modeling of a part may further include, in any combination, any one or more of the following preferred forms.

In one preferred form, the method comprises classifying, by the one or more processors, the deviation.

In another preferred form, revising the three-dimensional reference design of the part includes inverting, by the one or more processors, the deviation between the first electronic file and the second electronic file and applying the inverted deviation to the three-dimensional reference design.

In another preferred form, the first electronic file is one of a computer-aided design file or results of a three-dimensional scan of a previously manufactured part as a three-dimensional mesh or a three-dimensional point cloud.

In another preferred form, collecting metrology data for the part comprises performing a three-dimensional scan of the part and the second electronic file comprises results of the three-dimensional scan of the part.

In another preferred form, comparing the first electronic file and the second electronic file comprises at least one of generating or transforming the second electronic file into a vertex structure and transforming the first electronic file into a data file format with the same amount of total vertices as the second electronic file, with each vertex on the second electronic file and each vertex on the first electronic file having a 1:1 correspondence or generating or transforming the first electronic file into a vertex structure and transforming the second electronic file into a data file format with the same amount of total vertices as the first electronic file, with each vertex on the second electronic file and each vertex on the first electronic file having a 1:1 correspondence.

In another preferred form, the deviation between the first electronic file and the second electronic file is determined by calculating a distance between each corresponding vertex.

In another preferred form, collecting the metrology data for the part comprises performing in-process monitoring during manufacturing of the part and the second electronic file comprises a combination of the results of the three-dimensional scan of the part and results of the in-process monitoring.

In accordance with another example of the present invention, a tangible, non-transitory computer-readable medium stores instructions for the inverse modeling of a part, that when executed by one or more processors cause the one or more processors to: receive a first electronic file comprising a three-dimensional reference design of a part and store the first electronic file in a computer memory; receive a second electronic file comprising metrology data for a part manufactured based on the first electronic file and store the second electronic file in the computer memory; compare the first electronic file and the second electronic file and determine a deviation based on the comparison of the first electronic file and the second electronic file; determine whether the deviation is acceptable; and execute one of: (a) in the event the deviation is determined not to be acceptable, revise the three-dimensional reference design of the part or modifying a manufacturing process for the part; or (b) in the event the deviation is determined to be acceptable, store the three-dimensional reference design in the computer memory.

In further accordance with any one or more of the foregoing examples of the present invention, a tangible, non-transitory computer-readable medium storing instructions for the inverse modeling of a part may further include, in any combination, any one or more of the following preferred forms.

In one preferred form, revising the three-dimensional reference design of the part includes inverting the deviation between the first electronic file and the second electronic file and applying the inverted deviation to the three-dimensional reference design.

In another preferred form, the first electronic file is one of a computer-aided design file or results of a three-dimensional scan of a previously manufactured part as a three-dimensional mesh or a three-dimensional point cloud.

In another preferred form, the metrology data for the part comprises a three-dimensional scan of the part and the second electronic file comprises results of the three-dimensional scan.

In another preferred form, the metrology data for the part comprises data from in-process monitoring during manufacturing of the part and the second electronic file comprises a combination of results of the three-dimensional scan of the part and the data from the in-process monitoring.

In accordance with another example of the present invention, a system configured to provide inverse modeling of a part comprises a computer memory, one or more processors communicatively coupled to the computer memory, and an inverse modeling application stored in the computer memory. The inverse modeling application comprises computing instructions configured to execute on the one or more processors that, when executed by the one or more processors, causing the one or more processors to: receive a first electronic file comprising a three-dimensional reference design of a part and store the first electronic file in the computer memory; receive a second electronic file comprising metrology data for a part manufactured based on the first electronic file and store the second electronic file in the computer memory; compare the first electronic file and the second electronic file and determine a deviation based on the comparison of the first electronic file and the second electronic file; determine whether the deviation is acceptable; and execute one of: (a) in the event the deviation is determined not to be acceptable, revise the three-dimensional reference design of the part or modify a manufacturing process for the part; or (b) in the event the deviation is determined to be acceptable, store the three-dimensional reference design in the computer memory.

In further accordance with any one or more of the foregoing examples of the present invention, a system configured to provide inverse modeling of a part may further include, in any combination, any one or more of the following preferred forms.

In one preferred form, revising the three-dimensional reference design of the part includes inverting the deviation between the first electronic file and the second electronic file and applying the inverted deviation to the three-dimensional reference design.

In another preferred form, the first electronic file comprises one of a computer-aided design file or results of a three-dimensional scan of a previously manufactured part as a three-dimensional mesh or a three-dimensional point cloud.

In another preferred form, the metrology data for the part comprises a three-dimensional scan of the part and the second electronic file comprises results of the three-dimensional scan.

In another preferred form, the metrology data for the part comprises data from in-process monitoring during manufacturing of the part and the second electronic file comprises a combination of results of the three-dimensional scan of the part and the data from the in-process monitoring.

In accordance with another example of the present invention, a method for inverse modeling of a manufacturing tool, comprises: importing, by one or more processors, a first electronic file comprising a three-dimensional reference design of a manufacturing tool into a computer memory; preparing the manufacturing tool based on the first electronic file; manufacturing a part using the manufacturing tool; collecting metrology data for the part, creating a second electronic file, by the one or more processors, comprising the collected metrology data for the part, and saving, into the computer memory, the second electronic file; comparing, by the one or more processors, the second electronic file and a third electronic file comprising a three-dimensional reference design of the part and determining a deviation between the second electronic file and the third electronic file based on the comparison of the second electronic file and the third electronic file; determining whether the deviation is acceptable; and executing one of: (a) in the event the deviation is determined not to be acceptable, modifying the manufacturing tool and/or the first electronic file; or (b) in the event the deviation is determined to be acceptable, continuing to manufacture the part using the manufacturing tool.

In further accordance with any one or more of the foregoing examples of the present invention, a method for inverse modeling of a manufacturing tool may further include, in any combination, any one or more of the following preferred forms.

In one preferred form, the method comprises classifying, by the one or more processors, the deviation.

In another preferred form, the manufacturing tool is a mold.

In another preferred form, modifying the first electronic file comprises inverting, by the one or more processors, the deviation between the second electronic file and the third electronic file and applying the inverted deviation to the first electronic file and preparing a new manufacturing tool based on application of the inverted deviation to the first electronic file.

In another preferred form, modifying the manufacturing tool comprises making physical changes to the manufacturing tool.

In another preferred form, collecting metrology data for the part comprises performing a three-dimensional scan of the part and the second electronic file comprises results of the three-dimensional scan of the part.

In another preferred form, collecting the metrology data for the part comprises performing in-process monitoring during manufacturing of the part and the second electronic file comprises a combination of the three-dimensional scan of the part and results of the in-process monitoring.

Advantages will become more apparent to those of ordinary skill in the art from the following description of the examples which have been shown and described by way of illustration. As will be realized, the present examples may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an example of a particular aspect of the disclosed systems and methods and that each of the Figures is intended to accord with a possible example thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present examples are not limited to the precise arrangements and instrumentalities shown.

FIG. 1 is an illustration of an exemplary manufacturing system;

FIG. 2 is an illustration of an example inverse modeling system of the manufacturing system of FIG. 1;

FIG. 3 is a flowchart of an example inverse modeling method for a part; and

FIG. 4 is a flowchart of an example inverse modeling method for a manufacturing tool.

The Figures depict examples for purposes of illustration only. Alternatives to the systems and methods illustrated herein may be employed without departing from the principles of the invention described herein.

### DETAILED DESCRIPTION

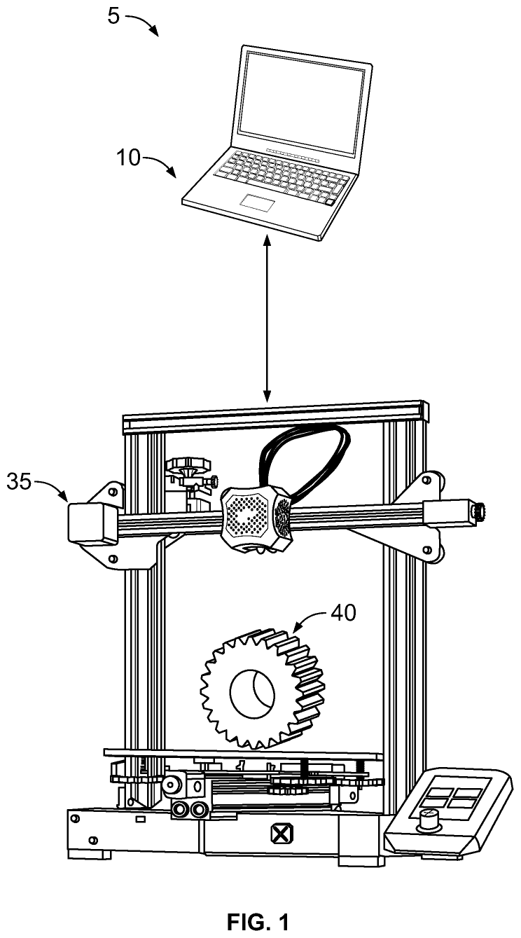

FIG. 1 illustrates an exemplary manufacturing system 5 that includes an inverse modeling system 10 and a manufacturing tool (e.g., three-dimensional (3D) printer 35) that can be in communication with system 10 and can be used to manufacture a part (e.g., gear 40). Although the manufacturing tool is shown and described herein in reference to 3D printer 35, the manufacturing tool can be any type of manufacturing tool, such as an automated or manual mold, a computer numerical control (CNC) machine, an additive manufacturing machine, etc. In addition, although the part is shown and described herein as gear 40, the manufactured part could be any manufactured part.

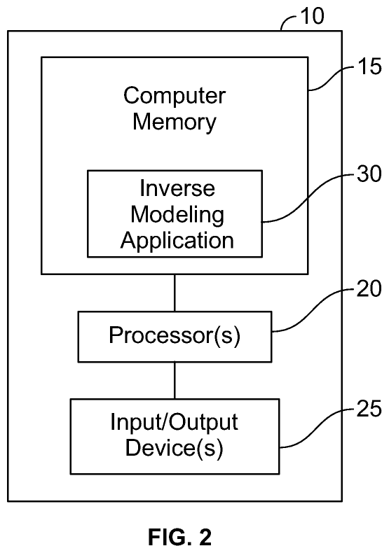

Referring to FIG. 2, an example system 10 for providing inverse modeling of a part or manufacturing tool is illustrated. System 10 can be any type of computing device, such as a computer, laptop computer, workstation, tablet, etc., and generally includes: a computer memory 15, one or more processors 20, such as CPUs, GPUs, etc., that are communicatively coupled to computer memory 15, and one or more input/output devices 25, such as keyboards, displays, touchscreens, etc. One or more processors 20 can be on-site processors and/or one or more processors of cloud-based servers. In addition, computer memory 15, which is a term of art and can include a single computer memory or multiple computer memories, stores data (e.g., a three-dimensional reference design) for later access and use by processor(s) 20.

An inverse modeling application 30 can be stored in computer memory 15, or on any tangible, non-transitory computer-readable medium, and can include computing instructions configured to be executed on processor(s) 20 to at least partially implement/execute a method 100 for inverse modeling of a part (e.g., gear 40) and/or a method 200 for inverse modeling of a manufacturing tool (e.g., 3D printer 35), where a user may be involved in programming/running the manufacturing tool, providing data, etc., to system 10 or otherwise manipulating input/output devices 25 to cause the input/output of such data.

To perform inverse modeling of a part (e.g., gear 40), inverse modeling application 30, when executed on processor(s) 20, can execute method 100 and cause processor(s) 20 execute one or more steps of method 100 below to perform at least a portion of the inverse modeling of the part.

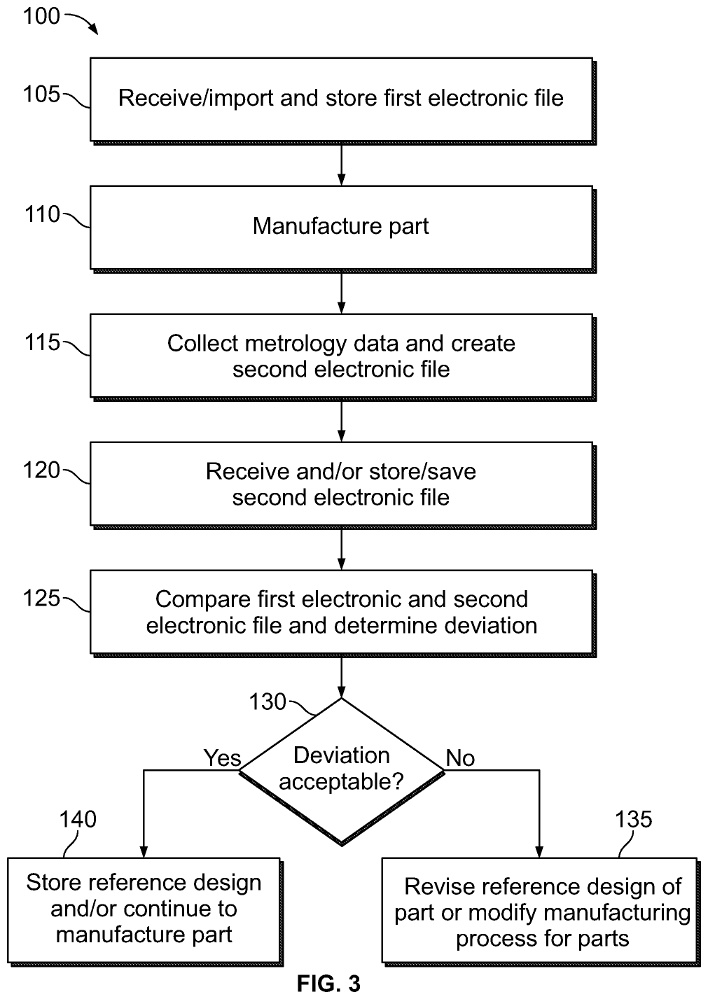

Referring to FIG. 3, an example method 100 for inverse modeling a part (e.g., gear 40) is illustrated. System 10 and method 100 can be used, for example, with manufacturing system 5 for rapid prototyping a new part design using additive manufacturing (i.e., 3D printing), to make welding/grinding improvements, etc. System 10 and method 100 can also be used to create a new design to automatically create a new part, to automatically subtract a portion from a new part (e.g., with grinding or machining), to machine a new part using the inverse model as a template to adjust the CAM path, etc. A possible advantage of method 100 is that a new part could be manufactured by changing only the design/design parameters of the part itself, with process parameters remaining unchanged, which could result in the manufacture of acceptable parts with less manufacturing iterations/shorter time. In addition, method 100 can overcome the limitations of physics-based simulation by collecting data in-process and post-process, processing them to train models to predict the inspection results from the in-process data given the process parameter.

At Step 105 of method 100, a first electronic file that includes a three-dimensional reference design of a part (e.g., gear 40) is received/imported by processor(s) 20 and is stored in computer memory 15. The three-dimensional reference design of the first electronic file can be, for example, a computer-aided design file of the part (e.g., gear 40), the results of a three-dimensional scan of a previously manufactured part as a three-dimensional mesh or a three-dimensional point cloud, etc. If the three-dimensional reference design and/or electronic file is created on system 10, the first electronic file would be stored in computer memory 15 and would not necessarily be received or imported.

At Step 110, the part (e.g., gear 40) is manufactured based on the three-dimensional reference design of the part in the first electronic file. The manufacture of the part can be carried out using a manufacturing tool (e.g., 3D printer) by system 10 or by a user. For example, if the part is manufactured via 3D printing, processor(s) 20 or the user can transfer the three-dimensional reference design of the first electronic file, or instructions based on the three-dimensional reference design, to 3D printer 35. If the part is manufactured via additive manufacturing, processor(s) 20 or the user can transfer the three-dimensional reference design of the first electronic file, or instructions based on the three-dimensional reference design, to the additive manufacturing machine. If the part is machined, processor(s) 20 or the user can transfer the three-dimensional reference design of the first electronic file, or instructions based on the three-dimensional reference design, to a CNC machine. If the part is manufactured via a molding process, the user can proceed to mold the part and/or processor(s) 20 or the user can transfer molding instructions based on the three-dimensional reference design, to an automated molding machine.

In addition, a manufacturing parameter for the part could be defined and the part can be manufactured based on the first electronic file and the manufacturing parameter. For example, the manufacturing parameter could be process parameters (e.g., material, temperature, pressure, etc.) and/or design parameters (e.g., defining additive manufacture or subtractive manufacturing parameters, defining 3D printing parameters, etc.).

At Step 115, metrology data is collected for the part (e.g., gear 40) manufactured based on the first electronic file and a second electronic/data-package file is created that includes the results of the metrology data collection. For example, collecting metrology data for the manufactured part could include performing a three-dimensional scan of the manufactured part, for example, as described in U.S. patent application Ser. No. 18/183,767, filed Mar. 14, 2023, and entitled METROLOGY 3D SCANNING SYSTEM AND METHOD, the entirety of which is incorporated herein by reference, and the second electronic file could include the results of the three-dimensional scan. In addition, collecting metrology data could include collecting data from in-process monitoring (e.g., in-situ monitoring such as two-dimensional (2D) images, thermographic images, 3D scans, etc.) during manufacture of the part. The data could be information such as 2D RGB or RGB-D data captured from vision, thermal, or other cameras with or without accurate 3D localization data (e.g., one pixel in the 2D RGB data can be 1:1 corresponded to the 3D voxel or vertex allowing the processor to combine the result of in-process monitoring data and the 3D scan). The second electronic file could then include the results of the in-process monitoring and/or a combination of results of the 3D scan and the data from the in-process monitoring (e.g., 2D RGB or thermal data can be reconstructed to 3D and aligned into the 3D scan of the part; 2D RGB data can be textured onto the 3D scan of the part, etc.).

At Step 120, the second electronic file is received by processor(s) 20 (e.g., if the second electronic file is created by another system) and/or is stored/saved in computer memory 15 (e.g., if the second electronic file is created by system 10).

At Step 125, processor(s) 20 compares the first electronic file and the second electronic file and determines a deviation based on the comparison. This can include at least one of generating or transforming the second electronic file into a vertex structure and transforming the first electronic file into a data file format with the same amount of total vertices as the second electronic file, with each vertex on the second electronic file and each vertex on the first electronic file having a 1:1 correspondence or generating or transforming the first electronic file into a vertex structure and transforming the second electronic file into a data file format with the same amount of total vertices as the first electronic file, with each vertex on the second electronic file and each vertex on the first electronic file having a 1:1 correspondence.

Global scale parameters (e.g., scaling differences) can also be determined between the first electronic file and the second electronic file. For example, a course alignment between the first electronic file and the second electronic file can be determined and initial 3D data correspondences can be calculated. Using the coarse alignment, the closest position (and the face containing it) on the measurement data can be found for each reference vertex. An R-Tree can be used to efficiently search for candidate faces in the measurement data and find the closest positions. A score can then be calculated by summing the distances from each reference vertex to the closest position in the part in the second electronic file. The part in first electronic file and/or the part in second electronic file can then be translated, rotated, and/or scaled so that the global scale parameters are as close as possible. Non-linear Least Squares can be used to solve for the optimal translation, rotation, and scale transform for the first electronic file that will globally minimize the point-to-plane distance between the reference vertices and the corresponding faces in the second electronic file. This is effectively Point-to-Plane Iterative Closest Point (ICP) with the addition of scale. Huber Loss can also be used in the optimization, which is less sensitive to outliers or artifacts in the measurement data than squared or absolute loss are. Finally, a random subset of the reference vertex correspondences can be used for the optimization to reduce computation requirements.

Accounting for any global scale error first can be important because it can enable more accurate correspondence between the vertices of the first electronic file and the corresponding points on the surface of the part of the second electronic file. When the scales of the part in the first electronic file and the part in the second electronic file are different, it increases the ambiguity of where the corresponding point is, especially at corners.

The deviation can then be determined by calculating a distance between each corresponding vertex in the second electronic file and the first electronic file.

Optionally, after the deviation has been determined, processor(s) 20 and/or the user can also classify the deviation. For example, classifications of the deviation could include one or more of: part failure due to global inaccuracy (e.g., the average deviation across the overall dimension is beyond acceptable tolerance); part failure due to local inaccuracy (e.g., the maximum deviation is beyond acceptable tolerance); part failure due to warping (e.g., the inspection results are twisted against the 3D reference design), etc.

At Step 130, once the deviation has been determined, and optionally classified, processor(s) 20 or the user determines whether the deviation (and/or classification if applicable) is acceptable. For example, a deviation's maximum tolerance can be determined by the original designer and this data may be saved within the first electronic file, the three-dimensional reference model, a separate 2D drawing describing the tolerances, data packages such as QIF or PMI, etc. There also can be classification, which can be performed by a human manually labeling a deviation (which could include one more than vertices deviating) as a failure of that region or the entire part due to that region, or a machine learning algorithm indicating a failure after learning from the previously labeled data.

In the event the deviation (and/or classification if applicable) is determined not to be acceptable, at Step 135, the three-dimensional reference design of the part (e.g., gear 40) can be revised (e.g., shrink after molding is making the part small and the three-dimensional reference design can be revised to make certain dimensions larger so that after shrink the manufactured part matches the original three-dimensional reference design) and/or the manufacturing process for the part can be revised. For example, revising the three-dimensional reference design for the part can include inverting the deviation between the first electronic file and the second electronic file and applying the inverted deviation to the three-dimensional reference design to create a modified three-dimensional reference design, which can be used to manufacture a second part. In addition, revising the manufacturing process for the part could include adjusting a tool path of a CNC machine or other manufacturing system, adjusting the file/instructions for 3D printing or additive manufacturing, adjusting or remanufacturing a mold, etc. The method could then continue with Step 110 and a second part manufactured with the modified three-dimensional reference design and/or revised manufacturing process parameters.

In the event the deviation (and/or classification if applicable) is determined to be acceptable, at Step 140, the three-dimensional reference design of the first electronic file is stored in computer memory 15 and/or the part (e.g., gear 40) is continued to be manufactured based on the three-dimensional reference design of first electronic file.

The inverse modeling method described above can also be used to predict an “expected deviation” (e.g., final part quality) from prior determined deviations and electronic files. For example, if multiple iterations of parts (e.g., gear 40) were manufactured using the above inverse modeling method, a model can be trained to predict what the expected deviation will be based on changes made to the three-dimensional reference design and/or to the manufacturing process parameters by using the cycling of the inverse modeling method (possibly including the in-process data) as the training data set.

To perform inverse modeling of a manufacturing tool, inverse modeling application 30, when executed on processor(s) 20, can execute method 200 and cause processor(s) 20 execute one or more steps of method 200 below to perform at least a portion of the inverse modeling of the manufacturing tool.

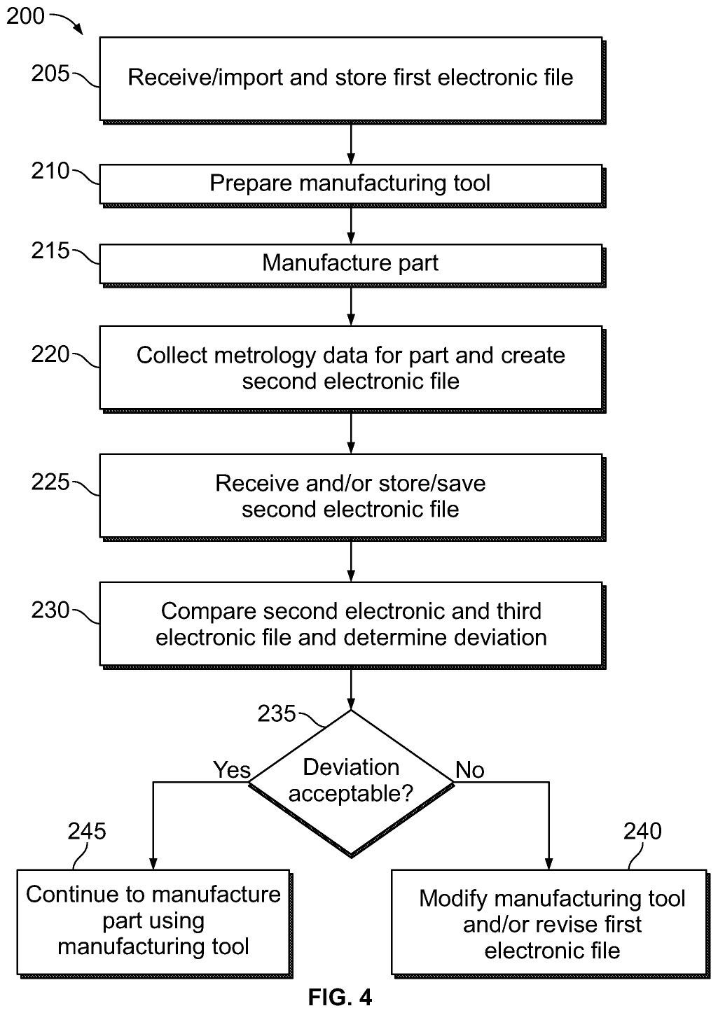

Referring to FIG. 4, an example method 200 for inverse modeling of a manufacturing tool is illustrated. At Step 205 of method 200, a first electronic file that includes a three-dimensional reference design of a manufacturing tool is received/imported by processor(s) 20 and is stored in computer memory 15. The three-dimensional reference design of the first electronic file can be, for example, a computer-aided design file of the manufacturing tool (e.g., a mold), the results of a three-dimensional scan of a previously manufactured manufacturing tool as a three-dimensional mesh or a three-dimensional point cloud, etc. If the three-dimensional reference design and/or electronic file is created on system 10, the first electronic file would be stored in computer memory 15 and would not necessarily be received or imported.

At Step 210, the manufacturing tool is prepared based on the first electronic file. For example, the manufacturing tool could be manufactured (e.g., a mold created), set up/programmed (e.g., a CNC machine or 3D printer), repaired, adjusted, etc.

At Step 215, a part (e.g., gear 40) is manufactured using the manufacturing tool (e.g., a mold, 3D printer 35, etc.). The manufacture of the part can be carried out by system 10 or by a user. In addition, a manufacturing parameter for the part could be defined and the part can be manufactured based with the manufacturing tool and the manufacturing parameter. For example, the manufacturing parameter could be process parameters (e.g., material, temperature, pressure, etc.) and/or design parameters (e.g., defining additive manufacture or subtractive manufacturing parameters, defining 3D printing parameters, etc.).

At Step 220, metrology data is collected for the part (e.g., gear 40) manufactured with the manufacturing tool and a second electronic file is created that includes the results of the metrology data collection. For example, collecting metrology data for the manufactured part could include performing a three-dimensional scan of the manufactured part, for example, as described in U.S. patent application Ser. No. 18/183,767, filed Mar. 14, 2023, and entitled METROLOGY 3D SCANNING SYSTEM AND METHOD, the entirety of which is incorporated herein by reference, and the second electronic file could include the results of the three-dimensional scan. In addition, collecting metrology data could include collecting data from in-process monitoring (e.g., in-situ monitoring such as 2D images, thermographic images, 3D scans, etc.) during manufacture of the part. The data could be information such as 2D RGB or RGB-D data captured from vision, thermal, or other cameras with or without accurate 3D localization data (e.g., one pixel in the 2D RGB data can be 1:1 corresponded to the 3D voxel or vertex allowing the processor to combine the result of in-process monitoring data and the 3D scan). The second electronic file could then include the results of the in-process monitoring and/or a combination of results of the 3D scan and the data from the in-process monitoring (e.g., 2D RGB or thermal data can be reconstructed to 3D and aligned into the 3D scan of the part; 2D RGB data can be textured onto the 3D scan of the part, etc.).

At Step 225, the second electronic file is received by processor(s) 20 (e.g., if the second electronic file is created by another system) and/or is stored/saved in computer memory 15 (e.g., if the second electronic file is created by system 10).

At Step 230, processor(s) 20 compares the second electronic file and a third electronic file that includes a 3D reference design for the part (e.g., gear 40), as discussed above, and determines a deviation based on the comparison. This can include at least one of generating or transforming the third electronic file into a vertex structure and transforming the second electronic file into a data file format with the same amount of total vertices as the third electronic file, with each vertex on the third electronic file and each vertex on the second electronic file having a 1:1 correspondence or generating or transforming the second electronic file into a vertex structure and transforming the third electronic file into a data file format with the same amount of total vertices as the second electronic file, with each vertex on the third electronic file and each vertex on the second electronic file having a 1:1 correspondence.

Global scale parameters (e.g., scaling differences) can also be determined between the second electronic file and the third electronic file. For example, a course alignment between the second electronic file and the third electronic file can be determined and initial 3D data correspondences can be calculated. Using the coarse alignment, the closest position (and the face containing it) on the measurement data can be found for each reference vertex. An R-Tree can be used to efficiently search for candidate faces in the measurement data and find the closest positions. A score can then be calculated by summing the distances from each reference vertex to the closest position in the part in the third electronic file. The part in second electronic file and/or the part in third electronic file can then be translated, rotated, and/or scaled so that the global scale parameters are as close as possible. Non-linear Least Squares can be used to solve for the optimal translation, rotation, and scale transform for the second electronic file that will globally minimize the point-to-plane distance between the reference vertices and the corresponding faces in the third electronic file. This is effectively Point-to-Plane Iterative Closest Point (ICP) with the addition of scale. Huber Loss can also be used in the optimization, which is less sensitive to outliers or artifacts in the measurement data than squared or absolute loss are. Finally, a random subset of the reference vertex correspondences can be used for the optimization to reduce computation requirements.

Accounting for any global scale error first can be important because it can enable more accurate correspondence between the vertices of the second electronic file and the corresponding points on the surface of the part of the third electronic file. When the scales of the part in the second electronic file and the part in the third electronic file are different, it increases the ambiguity of where the corresponding point is, especially at corners.

The deviation can then be determined by calculating a distance between each corresponding vertex in the third electronic file and the second electronic file.

Optionally, after the deviation has been determined, processor(s) 20 and/or the user can also classify the deviation. For example, classifications of the deviation could include one or more of: part failure due to global inaccuracy (e.g., the average deviation across the overall dimension is beyond acceptable tolerance); part failure due to local inaccuracy (e.g., the maximum deviation is beyond acceptable tolerance); part failure due to warping (e.g., the inspection results are twisted against the 3D reference design), etc.

At Step 235, once the deviation has been determined, and optionally classified, processor(s) 20 or the user determines whether the deviation (and/or classification if applicable) is acceptable. For example, a deviation's maximum tolerance can be determined by the original designer and this data may be saved within the first electronic file, the three-dimensional reference model, a separate 2D drawing describing the tolerances, data packages such as QIF or PMI, etc. There also can be classification, which can be performed by a human manually labeling a deviation (which could include one more than vertices deviating) as a failure of that region or the entire part due to that region, or a machine learning algorithm indicating a failure after learning from the previously labeled data.

In the event the deviation (and/or classification if applicable) is determined not to be acceptable, at Step 240, the manufacturing tool can be modified (e.g., making physical changes the manufacturing tool (e.g., a mold) and/or the programming of the manufacturing tool (e.g., 3D printer 35, a CNC machine, etc.)) and/or the first electronic file for the manufacturing tool can be revised. For example, revising the first electronic file for the manufacturing tool can include inverting the deviation between the second electronic file and the third electronic file and applying the inverted deviation to the first electronic file and preparing a new manufacturing tool based on application of the inverted deviation to the first electronic file.

In the event the deviation (and/or classification if applicable) is determined to be acceptable, at Step 245, the part (e.g., gear 40) is continued to be manufactured using the manufacturing tool (e.g., 3D printer 35).

While various examples have been described above, this disclosure is not intended to be limited thereto. Variations can be made to the disclosed examples that are still within the scope of the appended claims.

The detailed description is to be construed as exemplary only and does not describe every possible example since describing every possible example would be impractical. Numerous alternative examples may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain examples are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location, while in other embodiments the processors may be distributed across a number of locations.

Those of ordinary skill in the art will recognize that a wide variety of modifications, alterations, and combinations can be made with respect to the above-described examples without departing from the scope of the invention, and that such modifications, alterations, and combinations are to be viewed as being within the ambit of the inventive concept.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A method for inverse modeling of a part, comprising:
importing, by one or more processors, a first electronic file comprising a three-dimensional reference design of a part into a computer memory;
manufacturing the part based on the first electronic file;
collecting metrology data for the part, creating a second electronic file, by the one or more processors, comprising the collected metrology data for the part, and saving, into the computer memory, the second electronic file;
comparing, by the one or more processors, the first electronic file and the second electronic file and determining a deviation based on the comparison of the first electronic file and the second electronic file;
determining, by the one or more processors, whether the deviation is acceptable; and
executing one of: (a) in the event the deviation is determined not to be acceptable, revising the three-dimensional reference design of the part or modifying a manufacturing process for the part; or (b) in the event the deviation is determined to be acceptable, continuing to manufacture the part based on the first electronic file.

2. The method of claim 1, comprising classifying, by the one or more processors, the deviation.

3. The method of claim 1, wherein revising the three-dimensional reference design of the part includes inverting, by the one or more processors, the deviation between the first electronic file and the second electronic file and applying the inverted deviation to the three-dimensional reference design.

4. The method of claim 1, wherein the first electronic file is one of a computer-aided design file or results of a three-dimensional scan of a previously manufactured part as a three-dimensional mesh or a three-dimensional point cloud.

5. The method of claim 1, wherein collecting metrology data for the part comprises performing a three-dimensional scan of the part and the second electronic file comprises results of the three-dimensional scan of the part.

6. The method of claim 5, wherein comparing the first electronic file and the second electronic file comprises at least one of:
generating or transforming the second electronic file into a vertex structure and transforming the first electronic file into a data file format with the same amount of total vertices as the second electronic file, with each vertex on the second electronic file and each vertex on the first electronic file having a 1:1 correspondence; or
generating or transforming the first electronic file into a vertex structure and transforming the second electronic file into a data file format with the same amount of total vertices as the first electronic file, with each vertex on the second electronic file and each vertex on the first electronic file having a 1:1 correspondence.

7. The method of claim 6, wherein the deviation between the first electronic file and the second electronic file is determined by calculating a distance between each corresponding vertex.

8. The method of claim 5, wherein collecting the metrology data for the part comprises performing in-process monitoring during manufacturing of the part and the second electronic file comprises a combination of the results of the three-dimensional scan of the part and results of the in-process monitoring.

9. A tangible, non-transitory computer-readable medium storing instructions for inverse modeling of a part, that when executed by one or more processors cause the one or more processors to:
receive a first electronic file comprising a three-dimensional reference design of a part and store the first electronic file in a computer memory;
receive a second electronic file comprising metrology data for a part manufactured based on the first electronic file and store the second electronic file in the computer memory;
compare the first electronic file and the second electronic file and determine a deviation based on the comparison of the first electronic file and the second electronic file;
determine whether the deviation is acceptable; and
execute one of: (a) in the event the deviation is determined not to be acceptable, revise the three-dimensional reference design of the part or modifying a manufacturing process for the part; or (b) in the event the deviation is determined to be acceptable, store the three-dimensional reference design in the computer memory.

10. The tangible, non-transitory computer-readable medium of claim 9, wherein revising the three-dimensional reference design of the part includes inverting the deviation between the first electronic file and the second electronic file and applying the inverted deviation to the three-dimensional reference design.

11. The tangible, non-transitory computer-readable medium of claim 9, wherein the first electronic file is one of a computer-aided design file or results of a three-dimensional scan of a previously manufactured part as a three-dimensional mesh or a three-dimensional point cloud.

12. The tangible, non-transitory computer-readable medium of claim 9, wherein the metrology data for the part comprises a three-dimensional scan of the part and the second electronic file comprises results of the three-dimensional scan.

13. The tangible, non-transitory computer-readable medium of claim 12, wherein the metrology data for the part comprises data from in-process monitoring during manufacturing of the part and the second electronic file comprises a combination of results of the three-dimensional scan of the part and the data from the in-process monitoring.

14. A system configured to provide inverse modeling of a part, the system comprising:
a computer memory;
one or more processors communicatively coupled to the computer memory; and
an inverse modeling application stored in the computer memory and comprising computing instructions configured to execute on the one or more processors, the inverse modeling application, when executed by the one or more processors, causing the one or more processors to:
receive a first electronic file comprising a three-dimensional reference design of a part and store the first electronic file in the computer memory;
receive a second electronic file comprising metrology data for a part manufactured based on the first electronic file and store the second electronic file in the computer memory;
compare the first electronic file and the second electronic file and determine a deviation based on the comparison of the first electronic file and the second electronic file;
determine whether the deviation is acceptable; and
execute one of: (a) in the event the deviation is determined not to be acceptable, revise the three-dimensional reference design of the part or modify a manufacturing process for the part; or (b) in the event the deviation is determined to be acceptable, store the three-dimensional reference design in the computer memory.

15. The system of claim 14, wherein revising the three-dimensional reference design of the part includes inverting the deviation between the first electronic file and the second electronic file and applying the inverted deviation to the three-dimensional reference design.

16. The system of claim 14, wherein the first electronic file comprises one of a computer-aided design file or results of a three-dimensional scan of a previously manufactured part as a three-dimensional mesh or a three-dimensional point cloud.

17. The system of claim 14, wherein the metrology data for the part comprises a three-dimensional scan of the part and the second electronic file comprises results of the three-dimensional scan.

18. The system of claim 17, wherein the metrology data for the part comprises data from in-process monitoring during manufacturing of the part and the second electronic file comprises a combination of results of the three-dimensional scan of the part and the data from the in-process monitoring.

19. A method for inverse modeling of a manufacturing tool, comprising:
importing, by one or more processors, a first electronic file comprising a three-dimensional reference design of a manufacturing tool into a computer memory;
preparing the manufacturing tool based on the first electronic file;
manufacturing a part using the manufacturing tool;
collecting metrology data for the part, creating a second electronic file, by the one or more processors, comprising the collected metrology data for the part, and saving, into the computer memory, the second electronic file;
comparing, by the one or more processors, the second electronic file and a third electronic file comprising a three-dimensional reference design of the part and determining a deviation between the second electronic file and the third electronic file based on the comparison of the second electronic file and the third electronic file;
determining whether the deviation is acceptable; and
executing one of: (a) in the event the deviation is determined not to be acceptable, modifying the manufacturing tool and/or the first electronic file; or (b) in the event the deviation is determined to be acceptable, continuing to manufacture the part using the manufacturing tool.

20. The method of claim 19, comprising classifying, by the one or more processors, the deviation.

21. The method of claim 19, wherein the manufacturing tool is a mold.

22. The method of claim 19, wherein modifying the first electronic file comprises inverting, by the one or more processors, the deviation between the second electronic file and the third electronic file and applying the inverted deviation to the first electronic file and preparing a new manufacturing tool based on application of the inverted deviation to the first electronic file.

23. The method of claim 19, wherein modifying the manufacturing tool comprises making physical changes to the manufacturing tool.

24. The method of claim 19, wherein collecting metrology data for the part comprises performing a three-dimensional scan of the part and the second electronic file comprises results of the three-dimensional scan of the part.

25. The method of claim 24, wherein collecting the metrology data for the part comprises performing in-process monitoring during manufacturing of the part and the second electronic file comprises a combination of the three-dimensional scan of the part and results of the in-process monitoring.
